(19) United States
(12) Patent Application Publication
(10) Pub. No.: US 2007/0274074 A1
(43) Pub. Date: Nov. 29, 2007

(54) Method and apparatus for communicating a status of a device in a packet-based communication network

(76) Inventors: Daniel Thomas Smires, Freehold, NJ (US); Jayakumar Rao, Marlboro, NJ (US); Mary Grikas, Colts Neck, NJ (US); Frank Joseph Amato, Berkeley Heights, NJ (US); Louis Mamakos, Lawrenceville, NJ (US)

Correspondence Address: DUANE MORRIS LLP;Suite 700, 1667 K Street, N.W., Washington, DC, 20006, US

(21) Appl. No.: 11/700,781

(22) Filed: Feb. 1, 2007

Related U.S. Application Data
(60) Provisional application No. 60/763,886, filed on Feb. 1, 2006.

(51) Int. Cl. F21V 33/00

(52) U.S. Cl. 362/253

(57) ABSTRACT

A system and method for provisioning a network connection at a remote node, including detecting a device condition, and generating a visual signal corresponding to the device condition. In certain disclosed embodiments, generating the visual signal includes illuminating a light source with a color and according to a cadence. In other disclosed embodiments, the generating the visual signal includes illuminating a plurality of light sources according to a cadence.

The disclosure claims the filing-date benefit of Provisional Application No. 60/763,886, filed Feb. 1, 2006, the specification of which is incorporated herein in its entirety.

### FIELD OF THE INVENTION

The present disclosure relates generally to systems and methods for provisioning and maintaining a network communications device. In particular, the present disclosure relates to systems and methods for providing visual signals corresponding to the status of a Voice-over-IP (VoIP) terminal adapter.

### BACKGROUND

In just a short time, VoIP has revolutionized the availability of affordable and advanced high-quality audio and visual communications. As VoIP has grown more popular, the size and complexity of service provider networks has increased immensely to handle the increased call volume and various service enhancements made possible by VoIP. As service (and/or equipment) provider networks grow, the task of provisioning service and maintaining it for a large customer base presents technological, logistical, and business challenges.

One example of prior art architecture for the remote end of a VoIP service provider network typically includes a connection device connected between a PSTN-based telephone and the network. The connection device translates analog signals required for the PSTN-based telephones and digital signals transmitted over the network. A failure in the ability to communicate (e.g., component failure, improper connection to the network or a power source, poor network traffic conditions and the like) is highly undesirable. If such condition occurs, it requires extensive assistance to be provided to the end user by service personnel. Further, these service personnel working remotely (e.g., over the phone, via an online “chat” session and the like) encounter difficulties when trying to properly diagnose the technical issues based on the performance issues as described by an end user. In the frequent case that these symptoms or descriptions are incomplete or inaccurate, time and other resources are wasted in attempting to provide a solution to the problem. As a result, customer frustration from expending their effort to deal with service problems grows. This situation often leads to customer churn, which consequently places financial stress on service providers to grow or maintain their services or networks.

Accordingly, there is a need in industry for technological solutions to improve and simplify end user experience in the setup and use of connection devices, especially those used for VoIP, and VoIP services.

### SUMMARY

Various disclosed embodiments are generally directed to a system for and a method of communicating a status of a device in a packet-based communication network. In one embodiment, a method is disclosed, including detecting a device condition, and generating a visual signal corresponding to the device condition. In certain embodiments, generating the visual signal includes illuminating a light source with a color and according to a cadence. In other embodiments, the generating the visual signal includes illuminating a plurality of light sources according to a cadence.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments, wherein:

FIG. 1 illustrates a flow chart describing an exemplary disclosed method;

FIG. 2 illustrates an exemplary blink cadence for a single-LED embodiment; and

FIG. 3 illustrates an exemplary blink cadence for a multiple-LED embodiment.

FIG. 4 illustrates an exemplary embodiment of a network communication device including a terminal adapter device; and

FIG. 5 illustrates another exemplary embodiment of a network communication device including a cordless IP communications device.

### DETAILED DESCRIPTION

One aspect of the present disclosure includes communicating a status of a device in a packet-based communication network. In one embodiment of the invention, the packet-based communication network is a VoIP network that establishes voice communication sessions according to the Session Initiation Protocol (SIP). SIP messages are exchanged between a VoIP service provider via one or more database and proxy servers) and one or more end users (via a network terminal adapter (TA)) to establish the communication session. One aspect of communicating a status in accordance with the subject invention includes detecting a TA device status. Another aspect includes generating a visual signal corresponding to the TA device status. Yet another aspect includes illuminating a light source with a color. An additional aspect includes illuminating a light source according to a cadence. A further aspect includes illuminating a plurality of light sources. Moreover, another aspect includes illuminating a plurality of light sources according to a cadence. In each aspect, the light source(s) are disposed either on the device whose status is being conveyed, on a display or panel separate from the device or a combination of these options.

Various disclosed embodiments advantageously enable the conveyance of device status information through visual cues using a light source. Categories of device status conditions include, but are not limited to, device actions in progress, successful actions, failed actions, device errors, software errors, firmware errors, network errors, and system errors.

Further, device status conditions include, but are not limited to the following:
bootup—the device is powered up and has not logged onto a network;
assignment—the device is trying to retrieve an IP address and a WAN ethernet link is not available;
configuration retrieval—the device is retrieving a configuration profile and an IP address has been assigned to the device;
successful download—the device has successfully downloaded a configuration profile and connects to a SIP server;
firmware action—the device is downloading a firmware image or writing it to flash memory;
successful registration and ready—the device has successfully registered with a SIP server and is ready to make or receive a VoIP call because, for instance, the phone is on the hook;
successful registration and not ready—the device has successfully registered with a SIP server but is not ready to make or receive a VoIP call because, for instance, the phone is off the hook;
voice error—the voice module is not functioning or when the WAN IP address is not available;
wide-area network error—the DHCP client is not functioning;
local-area network error—the DHCP server is not functioning;
wireless error—the wireless communications functions of the device are not functioning;
power supply error—there is a over- or under-voltage condition; and
voltage error—there is a FXS voltage error such as a foreign battery voltage present.

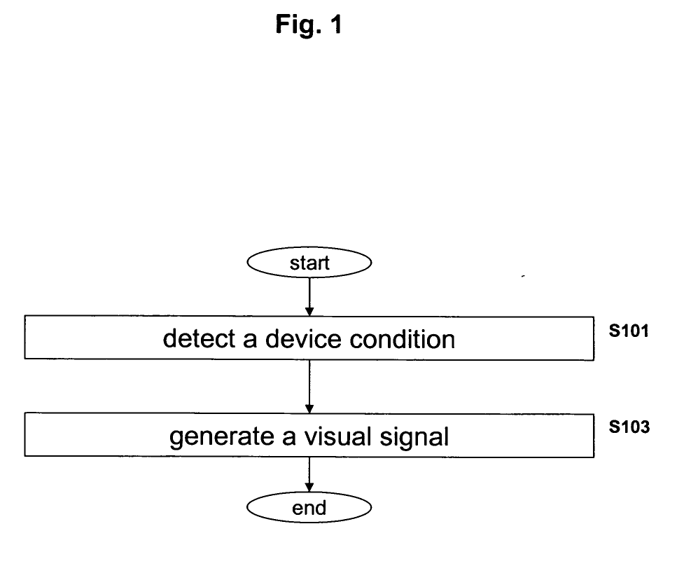

FIG. 1 illustrates a flow chart describing an exemplary disclosed method. In a first step, a device condition of the TA device is detected S101. In a second step, a visual signal is generated, the visual signal corresponding to the detected device condition S103. Generating a visual signal S103 includes, but is not limited to, illuminating a light source with a color, illuminating a light source according to a cadence, and illuminating a plurality of light sources according to a cadence.

In embodiments including a single light source, the single light source is preferably a multi-color light-emitting diode (LED). Generally, suitable light sources include, but are not limited to, lamps, fiber optics, and LEDs. Alternatively, a single source includes an array of single-color light sources, including, but not limited to, single-color LEDs. In embodiments including a plurality of light sources, the plurality of light sources include, but are not limited to, single-color and multi-color light sources.

Suitable light source colors include any color including white. Color choices may be constrained, for example, by the price or availability of certain colored light sources or color filters for use with an uncolored light source. Optionally, light source colors are chosen in accordance with generally-accepted color-associations. For example, green is optionally used to represent a good, normal, or working condition/status, yellow is optionally used to represent a cautionary status, and red is optionally used to represent a warning, problem, failure, or error status. Alternatively, colors are chosen according to a branding strategy. For example, blue and orange colors are optionally used to correspond to a corporate color scheme of a VoIP service or device provider.

In addition to color, a light source is operated according to a cadence or pattern to further convey device status information. Cadence includes a variety of factors, including an on/off status, blink frequency, blink intensity, blink patterns, pauses, and sequence repetition. In one embodiment, the cadence is constant illumination (the light is kept on, for example, as long as a predetermined device status exists). In another embodiment, the cadence includes at least one blink at a predetermined frequency. In yet another embodiment, the cadence includes blinks separated by a pause. In certain embodiments with more than one light source, the cadences of a predetermined number of light sources are optionally synchronized, offset, or operated in sequence. Further, sequences or patterns such as those described above are optionally repeated until a device status changes.

Using various combinations of the disclosed light sources, colors, and cadences, a variety of device status conditions are unambiguously communicated to an observer, such as an end-user. Accordingly, network & device conditions can be more easily determined and problems diagnosed. For example, during a troubleshooting session between service personnel and an end user, the end user can “read” the device status based on the color, frequency and cadence of the light sources and relay this information to the service personnel. In one embodiment of the invention, a plurality of different TA devices exist, yet they all contain the same visual signaling protocol so that diagnosis of a problem can rapidly be determined without having to consult various manufacturer brochures or specifications.

The table below illustrates various exemplary implementations of LED blink sequences used in a VoIP TA device communicating according to the SIP protocol:

| Condition | Single LED | Multiple LED |
|---|---|---|
| Bootup, device is powering up. | 1 blink (Green) | WAN OFF + PHONE |
| Device has not yet attempted to | blink cadence: one, 1 Hz on/off blink - | 1&2 OFF + 1 |
| log onto a network. | pause 1 second - repeat | blink Power (Green or Yellow) |
| | | blink cadence: one, 1 Hz on/off blink - |
| | | pause 1 second - repeat |
| Device is trying to retrieve a | 2 blinks (Green) | WAN ON* + PHONE |
| network (IP) address. WAN | blink cadence: two, 2 Hz on/off | 1&2 OFF + 2 |
| Ethernet link not available, | blinks - pause 1 second - repeat | blinks POWER (Green or |
| | | Yellow) |
| | | blink cadence: two, 2 Hz on/off |
| | | blinks - pause 1 second - repeat |
| Device is retrieving | 3 blinks (Green) | WAN ON* + PHONE |
| Configuration (Profile) - IP | blink cadence: three, 2 Hz on/off | 1&2 OFF + 3 |
| address has been assigned. | blinks - pause 1 second - repeat | blinks POWER (Green or |
| | | Yellow) |
| | | blink cadence: three, 2 Hz on/off |
| | | blinks - pause 1 second - repeat |
| Successful download of | 4 blinks (Green) | WAN ON* + PHONE |
| Configuration (Profile) | blink cadence: four, 2 Hz on/off | 1&2 OFF + 4 |
| connecting to SIP server | blinks - pause 1 second - repeat | blinks POWER (Green or |
| | | Yellow) |
| | | blink cadence four, 2 Hz on/off |
| | | blinks - pause 2 second - repeat |
| Downloading Firmware image or | Fast blinking (Yellow) | ALL LEDs blink fast, in sync with |
| writing to Flash. Device should | blink cadence: 4 Hz on/off blink - | each other |
| not be powered down. | repeat | blink cadence: 4 Hz on/off blink - |
| | | repeat |
| SIP registration successful - | Solid (Green) | WAN ON* + PHONE |
| ready to make calls (Phone is | | 1 and/or 2 ON |
| ON hook) | | (for line 1 and/or 2) + Solid |
| | | POWER (Green) |
| SIP registration successful | Solid (Yellow) | WAN ON* + PHONE |
| (Phone is OFF hook) | | 1 and/or 2 fast |
| | | blinking** |
| | | (for line 1 and/or 2) + Solid |
| | | Power (Green) |
| | | blink cadence: steady 3 Hz on/off |
| | | blink |
| Voice error condition | Slow, steady blinking (1 blink, | Slow, steady blinking PHONE 1 |
| voice module is NOT up | pause, 1 blink) (Red) | (1 blink, pause, 1 blink) + Slow, |
| WAN IP address is available | blink cadence: one, 1 Hz on/off blink - | steady blinking PHONE 2 |
| | pause 1 second - repeat | (1 blink, pause, 1 blink) |
| | | (PHONE 1&2 blinking |
| | | simultaneously) |
| | | blink cadence: one, 1 Hz on/off blink - |
| | | pause 1 second - repeat |
| WAN error condition | Slow, steady blinking (1 blink, | Slow, steady blinking WAN (1 |
| DHCP client not functioning | pause, 1 blink) (Red) | blink, pause, 1 blink) + PHONE |
| | blink cadence: one, 1 Hz on/off blink - | 1&2 OFF |
| | pause 1 second - repeat | blink cadence: one, 1 Hz on/off blink - |
| | | pause 1 second - repeat |
| LAN error condition | Slow, steady blinking (1 blink, | Slow, steady blinking LAN (1 |
| DHCP server not functioning | pause, 1 blink) (Red) | blink, pause, 1 blink) |
| | blink cadence: one, 1 Hz on/off blink - | blink cadence: one, 1 Hz on/off blink - |
| | pause 1 second - repeat | pause 1 second - repeat |
| Wireless error condition | Slow, steady blinking (1 blink, | Slow, steady blinking |
| | pause, 1 blink) (Red) | WIRELESS (1 blink, pause, 1 |
| | blink cadence: one, 1 Hz on/off blink - | blink) |
| | pause 1 second - repeat | blink cadence: one, 1 Hz on/off blink - |
| | | pause 1 second - repeat |
| Power supply error condition | Solid (Red) | Solid POWER (Red) + All |
| (over/under voltage conditions) | | other LEDs should be OFF |
| FXS voltage error condition | Fast blinking (Red) | Blink sequence PHONE |
| | blink cadence: 4 Hz on/off blink - | (1 blink, pause, pause, 2 blinks) |
| | repeat | [FXS port(s) with presence of |
| | | foreign voltage] |
| | | blink cadence: one, 2 Hz on/off blink - |
| | | pause 2 seconds - two, 2 Hz |
| | | on/off blink |

*When there is data activity, the WAN light will blink
**When there is voice activity, the PHONE light will blink
***When there is wireless activity, the WIRELESS light will blink

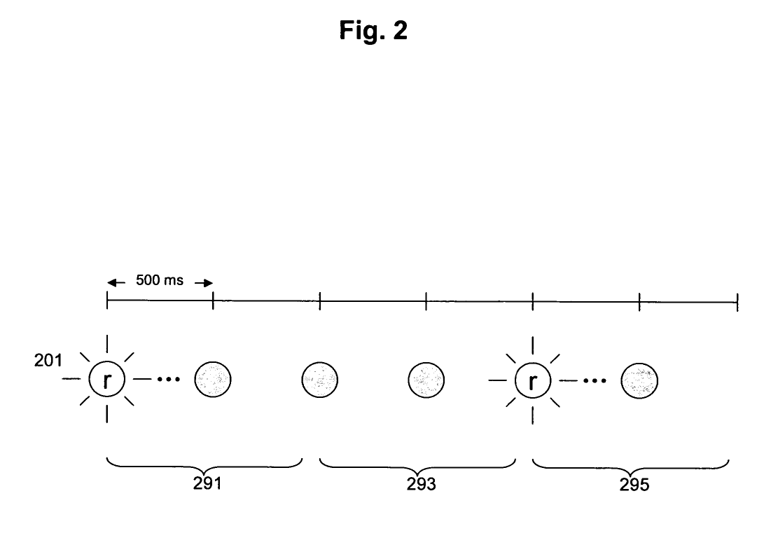

FIG. 2 illustrates an exemplary blink cadence for a single-LED embodiment. In particular, FIG. 2 represents to a voice error condition corresponding to the eighth entry of the above table. A voice error condition includes, but is not limited to, when a voice module of the TA device is not functioning, or when a network (WAN) IP address is not available.

Upon detection of a voice error condition, an LED 201 blinks according to a predetermined cadence. If the LED is a single color, the LED is optionally red. If the LED is multi-color, the LED optionally selects to illuminate red. In one embodiment, the predetermined cadence includes a first blink at 1 Hz (where a blink includes an on-state and an off-state completed in approximately a second) 291, a pause of a predetermined length (for instance, 1 second) 293, and a second blink at 1 Hz 295. Optionally, the first and second blinks are at first and second predetermined blink frequencies. The first and second predetermined blink frequencies are optionally different. Further, the sequence optionally repeats for the duration of the detected condition.

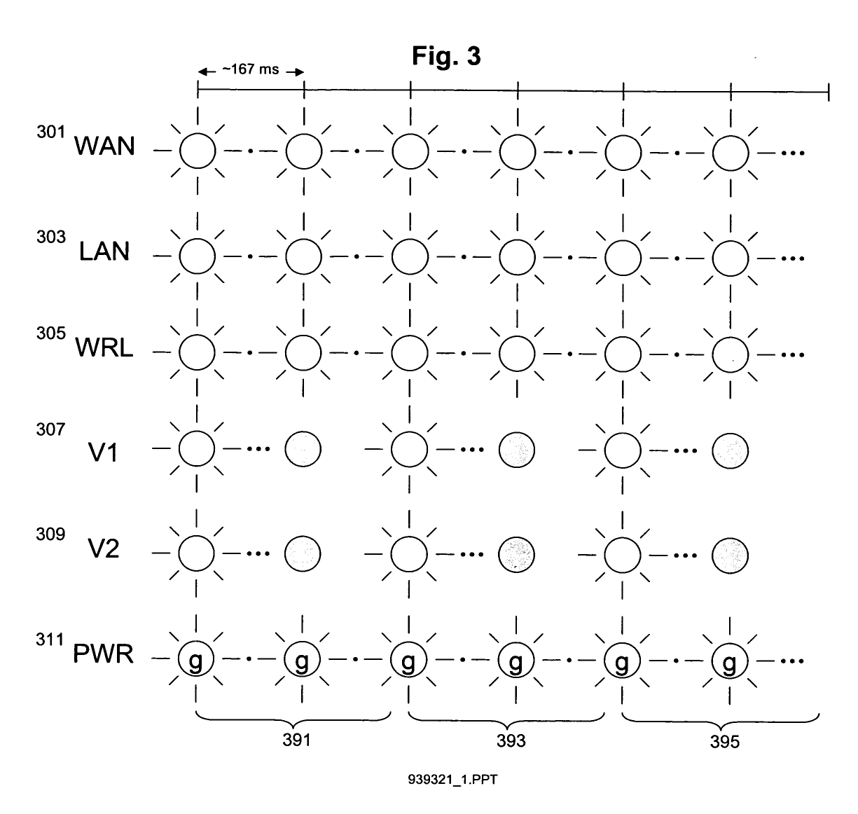

FIG. 3 illustrates an exemplary blink cadence for a multiple-LED embodiment. In particular, FIG. 3 represents a successful registration and not ready device condition corresponding to the seventh entry of the above table. A successful registration and not ready device condition includes, but is not limited to, when the TA device successfully registers with a SIP proxy server but is not ready to allow a call to be placed or received (for example, when the handset of the phone is off the hook).

Upon detection of a successful registration and not ready device condition, a first voice light 307 and a second voice light 309 illuminate in unison according to predetermined cadences. Optionally, the predetermined cadences are staggered or different. In one embodiment, the predetermined cadence includes rapid blinking at a predetermined frequency. Preferably, the predetermined frequency is 3 Hz (where a blink includes an on-state and an off-state completed three times in approximately a second). The predetermined frequencies are optionally different for the first voice light 307 and the second voice light 309. Further, the sequence optionally repeats for the duration of the detected condition. If a multicolor LED is used, the color optionally cycles through the available colors of the LED.

Further, if the condition of the power is good or normal, the power LED 311 is optionally illuminated green for a constant duration. The LED is optionally illuminated using any suitable color. Similarly, if the wide-area network, local-area network, and wireless conditions were good or normal, then the WAN LED 301, the LAN LED 303, and the WRL LED 305 are optionally illuminated for a constant duration. Illumination of the LEDs is optionally green or any other color.

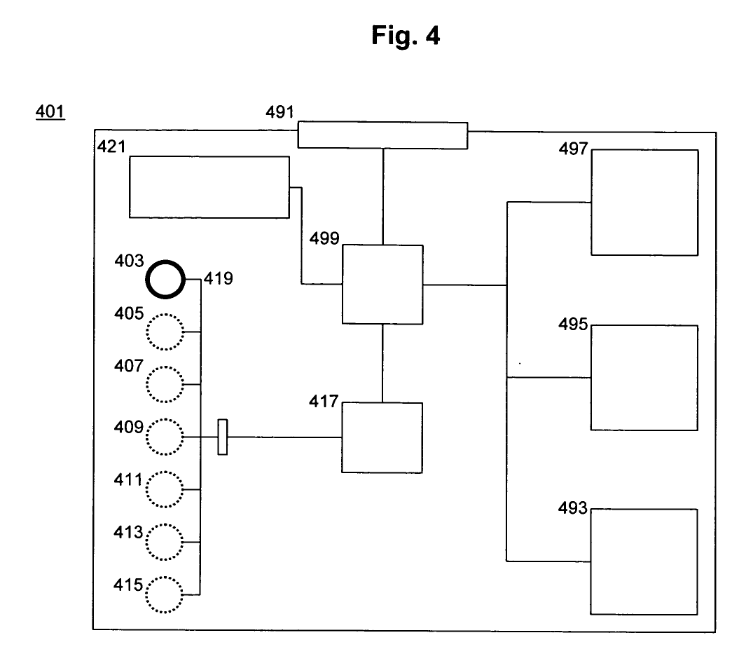

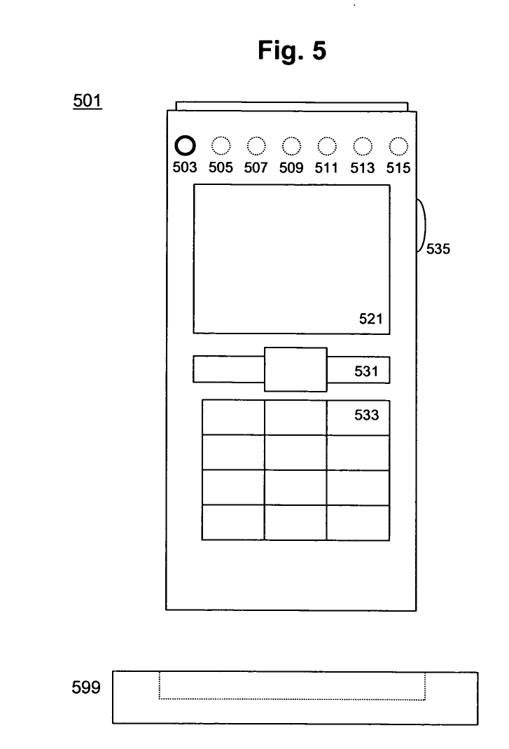

FIGS. 4-5 illustrate exemplary embodiments of a network communication device. FIG. 4 illustrates a schematic diagram of an exemplary TA device 401 including a light source 403. In alternative embodiments, the TA device 401 includes a plurality of light sources 403, 405, 407, 409, 411, 413, 415. The number of light sources is optionally chosen in accordance with the number of device conditions desired to be communicated. The TA device 401 includes a condition detector 499. The condition detector 499 is configured to detect an operational condition based on a received signal. Received signals include, but are not limited to, a power signal (for example, a satisfactory power signal, a power-up signal, a power-down signal, a power-surge signal, a low-power signal, etc.), an Internet Protocol (IP) signal addressing signal, a Session Initiation Protocol (SIP) signal, and an analog voice signal. These signals are optionally received from various subsystems of the TA device 401 including, but not limited to, a network/packet communications subsystem 497, a power management subsystem 495, and a voice/analog communications subsystem 493.

The TA device 401 further includes a timing device 417 and a driving circuit 419. The driving circuit 419 is configured to selectively illuminate the light source or plurality of light sources according to color and/or cadence. The TA device 401 optionally includes a textual or graphical display 421. Optionally, the display 421 is used to convey status or condition information in addition to, or in place of, the light source 403. The display optionally uses graphical display icons for these functions.

In selected embodiments, the TA device 401 includes an interface 491. The interface is optionally used to transmit device status/condition information and other data from the TA device 401 to an external device such as a computer, diagnostic equipment, or external display. Further, the interface optionally receives data or information for reconfiguring various operational aspects of the TA device 401. These operational aspects include, but are not limited to, the color and cadence of various status displays using the light 403, plurality of lights, or optional display 421.

FIG. 5 illustrates a front elevation view of an exemplary embodiment of a network communication device including a cordless IP communications device 501 including a light source 503. In alternative embodiments, the cordless device 501 includes a plurality of light sources 503, 505, 507, 509, 511, 513, 515. The plurality of light sources are connected to components similar in form and function to those described with respect to the TA device 401 schematically depicted in FIG. 4 and described above. Optionally, the cordless device 501 includes interface buttons 531, 533, 535. Specifically, interface button 531 can be a mode or action button to activate, cancel or otherwise select operational features of the cordless device 501. Interface button 533 can be an alpha-numeric keypad for data entry. Interface button 535 can be a graphical display controller such as a jog dial/selection button.

In various embodiments, the cordless device includes a textual or graphical display 521. Optionally, the display 521 is used to convey status or condition information in addition to, or in place of, the light source 503. The display 521 optionally uses graphical display icons for these functions. The number of light sources or icons is optionally chosen in accordance with the number of device conditions desired to be communicated. Optionally, the network communications device includes a charging dock or receiver 599. The dock/receiver is operably connected to the Internet via a computer, a router, a repeater, or other networked device. A condition detector is optionally included in either the cordless device 501 or the dock 599. Alternatively, a condition detector is included in both the cordless device 501 and the dock 599. If the condition detector is included separate from the light source 503 (or plurality of light sources) or the display 521 (if the display is used to convey device conditions), then communications channels between the device 501 and dock/receiver 599 are utilized to convey detected operational condition signals to one or more light sources for generating a visual signal corresponding to the device condition.

Additional device statuses or conditions are optionally represented by additional light sources, colors, and cadences. Alternate cadences include various combinations of blinks at predetermined frequencies or irregular intervals, pauses, and illumination held for a predetermined duration.

In alternative embodiments, the intensity of illumination of a light source is used to provide an additional dimension of visual information, for instance, to represent additional device conditions or sub-conditions. For example, intensity is optionally altered instead of, or in addition to, the color or cadence. Further, pulsing or oscillating the light source at irregular or changing frequencies is also optionally employed.

Process descriptions or blocks in flow charts may be understood as representing modules, segments, or portions of computer software or code which include one or more executable instructions for implementing specific logical functions or steps in the process, and alternate implementations (including implementations without a computer) are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

The embodiments disclosed herein for provisioning and maintaining a network device can be implemented using computer usable medium having a computer readable code executed by special purpose or general purpose computers.

What is claimed is:

1. A method of communicating a device condition of a packet-based communication network device comprising:
detecting the device condition based upon a signal selected from the group consisting of a power signal, an Internet Protocol (IP) addressing signal, and a Session Initiation Protocol (SIP) signal; and
generating a visual signal corresponding to the device condition.

2. The method of claim 1, wherein generating the visual signal includes illuminating a light source with a color and according to a cadence.

3. The method of claim 2, wherein the device condition is bootup, the color is green, and the cadence includes one blink followed by a pause.

4. The method of claim 2, wherein the device condition is assignment, the color is green, and the cadence includes two blinks followed by a pause.

5. The method of claim 2, wherein the device condition is configuration retrieval, the color is green, and the cadence includes three blinks followed by a pause.

6. The method of claim 2, wherein the device condition is successful download, the color is green, and the cadence includes four blinks followed by a pause.

7. The method of claim 2, wherein the device condition is firmware action, the color is yellow, and the cadence includes rapid blinking.

8. The method of claim 2, wherein the device condition is successful registration and ready, the color is green, and the cadence is continuous illumination.

9. The method of claim 2, wherein the device condition is successful registration and not ready, the color is yellow, and the cadence is continuous illumination.

10. The method of claim 2, wherein the device condition is voice error, the color is red, and the cadence includes a first blink and a second blink, the first blink and second blink being separated by a pause.

11. The method of claim 2, wherein the device condition is wide area network error, the color is red, and the cadence includes a first blink and a second blink, the first blink and second blink being separated by a pause.

12. The method of claim 2, wherein the device condition is local area network error, the color is red, and the cadence includes a first blink and a second blink, the first blink and second blink being separated by a pause.

13. The method of claim 2, wherein the device condition is wireless error, the color is red, and the cadence includes a first blink and a second blink, the first blink and second blink being separated by a pause.

14. The method of claim 2, wherein the device condition is power supply error, the color is red, and the cadence is continuous illumination.

15. The method of claim 2, wherein the device condition is voltage error, the color is red, and the cadence includes rapid blinking.

16. The method of claim 1, wherein generating the visual signal includes illuminating a plurality of light sources according to a cadence, the plurality of light sources including a wide-area network (WAN) light source, a local-area network (LAN) light source, a wireless (WRL) light source, a first voice light source, a second voice light source, and a power light source.

17. The method of claim 16, wherein the device condition is bootup, the WAN light source is off, the first voice light source is off, the second voice light source is off, and the cadence of the power light source includes one blink followed by a pause.

18. The method of claim 16, wherein the device condition is assignment, the WAN light source is on, the first voice light source is off, the second voice light source is off, and the cadence of the power light source includes two blinks followed by a pause.

19. The method of claim 16, wherein the device condition is configuration retrieval, the WAN light source is on, the first voice light source is off, the second voice light source is off, and the cadence of the power light source includes three blinks followed by a pause.

20. The method of claim 16, wherein the device condition is successful download, the WAN light source is on, the first voice light source is off, the second voice light source is off, and the cadence of the power light source includes four blinks followed by a pause.

21. The method of claim 16, wherein the device condition is firmware action, the cadences of the WAN light source, the first voice light source, the second voice light source, and the power light source includes rapid and synchronous blinking.

22. The method of claim 16, wherein the device condition is successful registration and ready, the WAN light source is on, at least one of the first and the second voice light sources is on, and the cadence of the power light source is continuous illumination.

23. The method of claim 16, wherein the device condition is successful registration and not ready, the WAN light source is on, the cadence of at least one of the first and the second voice light sources includes rapid blinking, and the cadence of the power light source is continuous illumination.

24. The method of claim 16, wherein the device condition is voice error, the cadences of the first and second voice light sources include a first blink and a second blink, the first blink and second blink being separated by a pause, the cadences of the first and second voice light sources further being synchronous.

25. The method of claim 16, wherein the device condition is wide area network error, the cadence of the WAN light source includes a first blink and a second blink, the first blink and second blink being separated by a pause, and the first and second voice light sources are off.

26. The method of claim 16, wherein the device condition is local area network error, and the cadence of the LAN light source includes a first blink and a second blink, the first blink and second blink being separated by a pause.

27. The method of claim 16, wherein the device condition is wireless error, and the cadence of the WRL light source includes a first blink and a second blink, the first blink and second blink being separated by a pause.

28. The method of claim 16, wherein the device condition is power supply error, the WAN light source is off, the LAN light source is off, the WRL light source is off, the first voice light source is off, the second voice light source is off, and the cadence of the power light source is continuous illumination.

29. The method of claim 16, wherein the device condition is voltage error, and the cadence of at least one of the first and the second voice light sources includes a first blink and two second blinks, the first blink and the two second blinks being separated by at least one pause.

30. A packet-based communication network device capable of communicating a device operational condition, comprising:
a condition detector configured to detect the device operational condition based upon a signal selected from the group consisting of a power signal, an Internet Protocol (IP) addressing signal, and a Session Initiation Protocol (SIP) signal; and
one or more light sources for generating a visual signal corresponding to the device condition.

31. The packet-based communication network of claim 30, further comprising:
a timing device including a local oscillator;
a driving circuit configured to illuminate the one or more light sources, wherein the one or more light sources includes at least one of a status light source, a wide-area network (WAN) light source, a local-area network (LAN) light source, a wireless (WRL) light source, a first voice light source, a second voice light source, and a power light source, the plurality of light sources being illuminated according to a cadence.
